(19) United States
(12) Patent Application Publication
(10) Pub. No.: US 2025/0296100 A1
(43) Pub. Date: Sep. 25, 2025

(54) SYSTEM AND METHOD FOR ELECTROSTATIC COATING

(71) Applicant: PowderCoil Technologies, LLC, Crown Point, IN (US)

(72) Inventors: Robert McShane, Evergreen Park, IL (US); Alex Duchak, Frankfort, IL (US); Steve Murray, Roselle, IL (US); Jeremy Murray, Dundee, IL (US); Parakh Kantawala, Chicago, IL (US)

(21) Appl. No.: 19/083,679

(22) Filed: Mar. 19, 2025

Related U.S. Application Data
(60) Provisional application No. 63/567,075, filed on Mar. 19, 2024.

(51) Int. Cl. B05B 5/03; B05B 15/20; B05B 15/50

(52) U.S. Cl. CPC B05B 5/032; B05B 15/20; B05B 15/50

(57) ABSTRACT

The present invention generally relates to an electrostatic coating system for spraying a stream of particles onto a medium, and in particular to a system comprising one or more apparatuses equipped with a powder coating suspension device. What is also contemplated is the use of a powder management system configured to supply predetermined powdered and air mixtures to the apparatus and a controller configured to adjust parameters of operation of both the apparatus and the powder management system. The present disclosure relates to an in-line industrial device able to coat paint, starch, thermoplastic materials, or any other powder material onto a medium by successively controlling a plurality of parameters.

### CROSS-REFERENCE TO RELATED APPLICATIONS

This application claims the benefit and priority to U.S. Provisional Patent Application Ser. No. 63/567,075, filed Mar. 19, 2024, which is incorporated by reference herein.

### COPYRIGHT NOTIFICATION

Portions of this patent application contain materials that are subject to copyright protection. The copyright owner has no objection to the facsimile reproduction by anyone of the patent document, or the patent disclosure, as it appears in the United States Patent and Trademark Office, but otherwise reserves all copyright rights whatsoever.

### FIELD OF THE DISCLOSURE

The present invention generally relates to a system for applying an electrostatic coating to a medium, and in particular to one or more apparatuses for spraying a stream of particles onto multiple surfaces of a medium, wherein the apparatus is equipped with a dual-chamber enclosure or with a plurality of variable openings for successive layer coating onto a medium.

### BACKGROUND OF THE DISCLOSURE

During the industrial coating process, a wide variety of media are covered with different surface materials. For example, paper may be covered with starch solutions for improved heat resistance characteristics, and metal sheeting may be coated with paint or latex for aesthetic value or corrosion protection of oxidizing surfaces. The coating of materials on media is widely used in the industry, and improved, cost-effective apparatuses, methods, and devices are continuously sought. The coating of liquids may utilize volatile solvents and require drying processes that create gas wastes requiring treatment. Apparatuses and methods for applying coating material in powder form to a medium do not suffer from the above shortcomings. Powders must adhere temporarily to the medium and be uniformly spread to prevent bumps or cause problems during post-treatment operations. Once applied to a medium, powders may require post-treatment operations such as baking to fix the powder permanently on the surface.

One of the known ways to adhere a powder to a surface without adding unnecessary agents or adhesives is by using the electrostatic adhering capacity of a charged stream of particles made from a powder suspended in a gas and placed in contact with a medium that has a different electrical energy or is grounded. The Law of Coulomb provides that electrostatic force felt by two bodies charged with the same polarity charge is a repulsive force, and the force felt by two bodies charged with opposite polarity is an attractive force. Once the powder particles in a stream are charged, either by removing or adding surface electrons, the particles are then drawn by the electromagnetic force to a grounded medium in proportion to Coulomb's Law. Another advantage of electrostatic charging of a stream of particles is the creation of repulsion forces between neighboring particles in the stream placed at equivalent energy to aid in the spatial distribution of the particles within the stream of particles. Additionally, charged particles are drawn by a stronger electrostatic force on a surface where other particles have not yet attached.

Electrostatic charges can be placed on a medium by contact electrification, triboelectric electrification, or physical rubbing of surfaces such as the friction of a balloon on a piece of clothing or the displacement of shoes over a carpet. Another way to create an electrical charge on an item is to circulate the item in a strong electrical field in excess of the breakdown strength of air, a field of such intensity that ionized particles are formed. These ions are collected on the surface of the item in the corona discharge zone around a conductor by moving the powder through the corona region. These particles exit the corona superficially charged with an ionic charge and are then vulnerable, due to their low mass, to electrostatic forces created by their charge. Particles of both conductive material and insulating material are vulnerable to corona charging. Nonconductive particles, since they are less likely to redirect the position of superficial ionic charges, are more likely to maintain their newly gained electrostatic charge.

Existing approaches to applying coatings include spraying a fine powder made of a material such as epoxy, polyester, polyurethane, or nylon that is electrostatically applied to a medium or substrate comprising a metal or other material that is grounded. After being applied, the powder is heated to cure and harden, generally in an oven.

Additionally known is the use of a high-level energy conductor located at the source of a stream of particles to ionize the powder or the use of a highly charged and dangerous conductive net structure placed in proximity to a medium. What is also known is the use of a chamber wherein the medium and the conductor are placed in contact with particles in the closed environment, or the use of an enclosure where ionized particles are collected after being placed in proximity to a conductor in a small enclosure before the ionized particle flow is directed onto a medium outside the enclosure. Drawbacks of these known technologies include the creation of corona discharges between the conductor surrounding low-level charge elements located in close proximity to the source of powder particles, the need to place the conductor in the path of the stream of particles, the creation of enclosed devices where high-level voltage must be managed, and distribution systems where the particles are not suspended in the air sufficiently enough to offer an optimal collection of the ions in the air. Although many of these devices are able to perform their intended functions in a workmanlike manner, none of them adequately addresses the combination of these drawbacks.

Further, existing systems and methods generally are either unable to apply a coating to multiple surfaces of a medium or require multiple passes to accomplish a desired coating. What is needed is an improved apparatus able to adequately fluidize the particles from a powder source and place them in a particle stream, an apparatus where conductors are protected and offset from the particle stream, an apparatus able to uniformly deposit the particles onto a medium, an apparatus able to avoid overspray and recover particles not deposited on the medium, and an apparatus able to (alone or jointly) coat multiple surfaces of a medium. Further control systems able to monitor and adjust the stream of particles in real time is desirable to ensure a specified coating is adequately applied. The present disclosure solves these and many other problems associated with currently available apparatuses for electrostatic coating.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended for determining the scope of the claimed subject matter.

The present invention generally relates to a system for applying a coating electrostatically to a medium, and in particular to a system comprising one or more electrostatic coating apparatuses for spraying a stream of particles onto a medium. In embodiments, the one or more apparatuses include a multivolume chamber coupled to a volute for mixing and spreading the stream of particles before they are distributed by one or more electrostatic emitters. In embodiments, discrete width control mechanisms are used to restrict the size of the particle spray and a rotational control mechanism permits the electrostatic emitters to rotate to finely tune the electrostatic field applied to the particle stream. In embodiments, a powder reclamation system operates to reclaim overspray and other particles that do not adhere to the medium, allowing particles to be collected, filtered, and recycled for subsequent reuse. The particle stream is deposited onto a medium moving past the electrostatic emitters. In embodiments, a shroud surrounds the medium and the emitters to ensure the particle stream is contained (making it available for easy reclamation and preventing particles from escaping the system).

The present disclosure relates to an in-line industrial device able to apply paint, starch, thermoplastics or any other powder material onto a medium by successively controlling a plurality of parameters, including the above-mentioned novel features, such as (but not limited to), in various embodiments, the size of an inside aperture within the enclosure, the rotation or angle of the electrostatic emitters, the speed of the medium moving between the electrostatic emitters, the powder velocity/flow rate, the pressure in the powder lines, the change in the flow of input gas, the change in the voltage or the location of the conductor, the measured film thickness applied to the medium previously, the weight and/or volume of powder delivered, the powder blower speed, the oven temperature, the vacuum flow rate, the excess air flow rate, temperature in various components of the apparatus, ambient temperature, measured pressure at various locations in the apparatus, and the weight of reclaimed powder.

### BRIEF DESCRIPTION OF THE SEVERAL VIEWS OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 is a front perspective view of an electrostatic coating system in accordance with an embodiment of the present disclosure.

FIG. 2 is a front perspective view of a reclamation system of the electrostatic coating system of FIG. 1 with components removed for illustrative purposes.

FIG. 3 is a side view of a powder deposition device of FIG. 1 in accordance with an embodiment of the present disclosure with the emitter in a retracted position.

FIG. 4 is a side view of the powder deposition device of FIG. 3 with the emitter in an extended position.

FIG. 5 is a front perspective view of the powder deposition device of FIG. 3 with the emitter in a retracted position.

FIG. 6 is a front perspective view of the powder deposition device of FIG. 3 with the emitter in an extended position.

FIG. 7 is a rear perspective view of the powder deposition device of FIG. 3 with the emitter in a retracted position.

FIG. 8 is a rear perspective view of the powder deposition device of FIG. 3 with the emitter in an extended position.

FIG. 9 is a side view of the electrostatic coating system of FIG. 1 with an oven illustrated.

FIG. 10 is a perspective view of the electrostatic coating system of FIG. 1 with components removed for illustrative purposes.

FIG. 11 is a perspective view of an oven shroud interface of an electrostatic coating system in accordance with the present disclosure with the deposition device and portions of the reclaim system removed for illustrative purposes.

FIG. 12 is a perspective view of an oven shroud plate of an electrostatic coating system in accordance with the present disclosure.

FIG. 13 is a perspective view of the oven shroud plate of FIG. 12 with the oven shroud extension cover plate removed.

FIG. 14 is a perspective view of an electrostatic coating system in accordance with the present disclosure showing the reclamation hoods and associated piping with the oven shroud extension cover plate removed.

FIG. 15 is a perspective view of the electrostatic coating system of FIG. 15 with the oven shroud extension cover plate inserted.

FIG. 16 is a side view of a pair of reclamation hoods showing the flow of excess powder into the reclamation hoods.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, a possible industrial embodiment of the disclosure centered around an improved electrostatic coating apparatus. This embodiment is described with detail sufficient to enable one of ordinary skill in the art to practice the disclosure. It is understood that each subfeature or element described in this embodiment of the disclosure, although unique, is not necessarily exclusive and can be combined differently and in a plurality of other possible embodiments because they show novel features. It is understood that the location and arrangement of individual elements, such as geometrical parameters within each disclosed embodiment, may be modified without departing from the spirit and scope of the disclosure. In addition, this disclosed embodiment can be modified based on a plurality of industrial and commercial necessities, such as, in a nonlimiting example, a large-scale coating process where several units are required at different locations along a production line or in a confined area when the atmospheric control of the stream of particles is to be recycled. The disclosed apparatus can be modified according to known design parameters to implement this disclosure within these specific types of operation. Other variations will also be recognized by one of ordinary skill in the art. The following detailed description is, therefore, not to be taken in a limiting sense.

### Electrostatic Coating System

The present disclosure relates to an electrostatic coating system 100 and its component parts as shown in the associated figures.

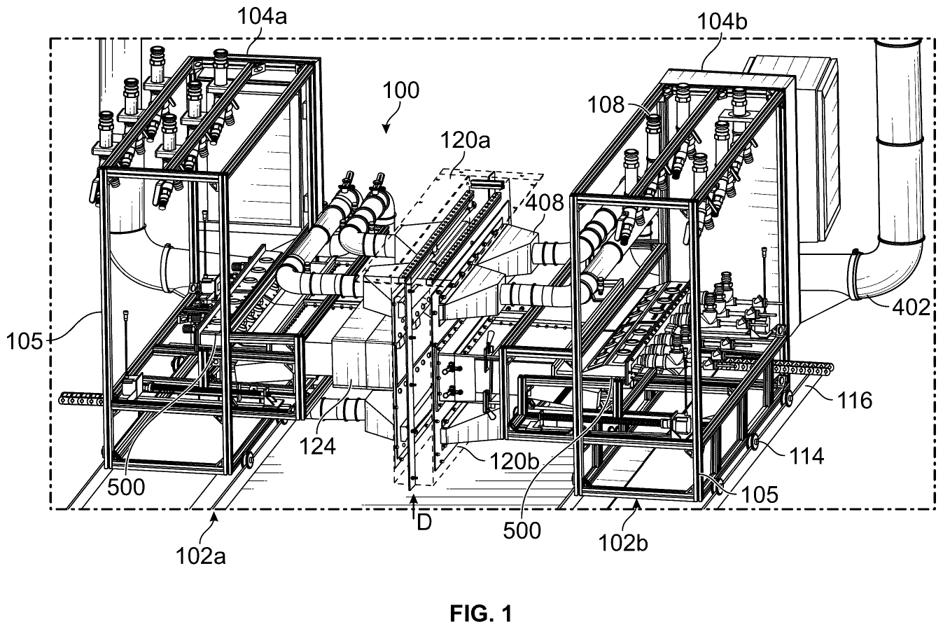

The electrostatic coating system 100 shown in FIG. 1 includes a first electrostatic apparatus 102a (or top-coating apparatus) for coating a top or first surface of a medium (not shown for clarity) that is separated horizontally from a second electrostatic apparatus 102b (or bottom-coating apparatus) for coating a bottom or second surface of the medium. This separation allows space for the medium to travel between the electrostatic apparatuses and minimizes interference between the electrostatic fields generated by each apparatus. As will be clear to one of ordinary skill in the art, other arrangements could also be employed. In an embodiment (not shown), the top-coating apparatus 102a and the bottom-coating apparatus 102b are offset vertically or laterally (which may be preferrable for use cases in which greater minimization of electrostatic interference is necessary).

In operation, the medium—which is a sheet of material—travels “upward” in direction D between the two electrostatic apparatuses 102a, 102b whereupon a coating is applied to one or both surfaces (termed a “top” and “bottom” surface in reference to FIG. 1). Once coated, the medium is passed through an oven, which cures the coating onto the medium. An oven shroud 120b surrounds the medium as it travels between the apparatuses 102a, 102b. The oven shroud 120b in the embodiment shown comprises a rectangular prism and comprises openings through which the apparatuses 102a, 102b are inserted; a horizontal portion 120a is disposed at the top end of the oven shroud 120b and extends laterally towards each of the apparatuses 102a, 102b. In an embodiment, one or more air knives are disposed between oven and the shroud and create a blanket between application area (i.e., the area between apparatuses 102a, 102b) and curing area (i.e., the area within the oven).

Oven shroud extensions 124 are disposed over and around the apparatuses 102a, 102b. In an embodiment, the oven shroud extensions 124 are sealed to the oven shroud 120b to prevent the coating material from escaping at the junction therebetween. In an embodiment, oven shroud extension cover plates 502 may be disposed “behind” each apparatus to prevent material from exiting the shroud and may be removed for maintenance on an apparatus. In an embodiment, the oven shrouds 120a, 120b, oven shroud extensions 124, and/or oven shroud extension cover plates 502 are made of a fiberglass material.

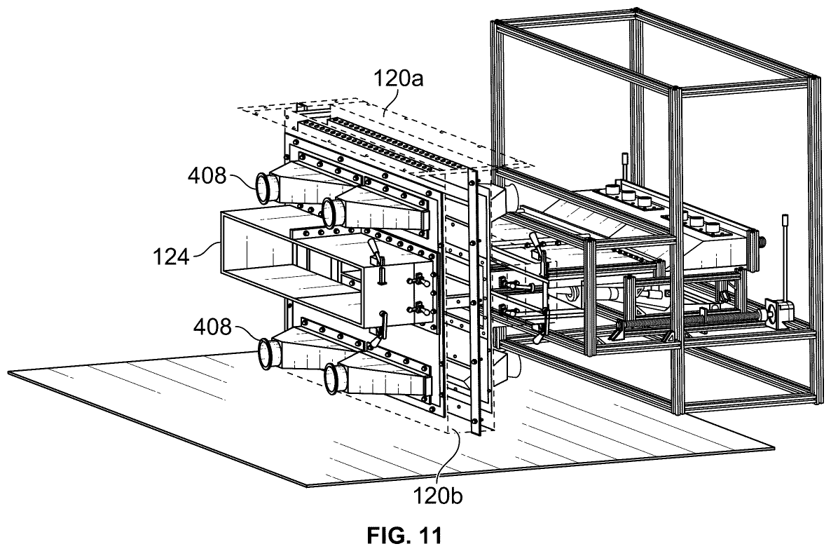

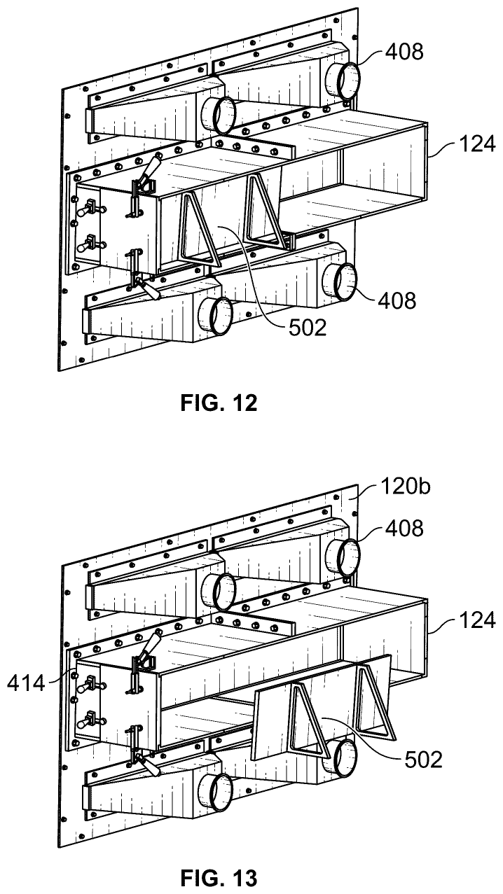

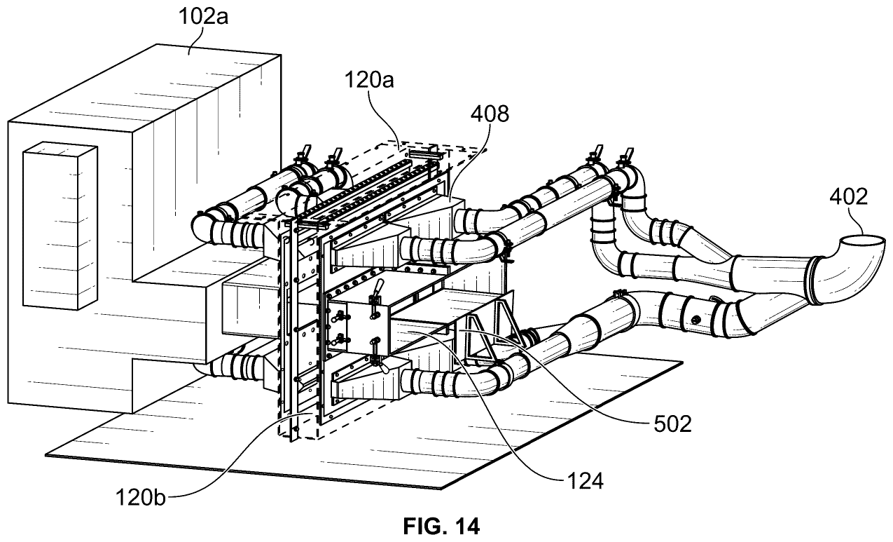

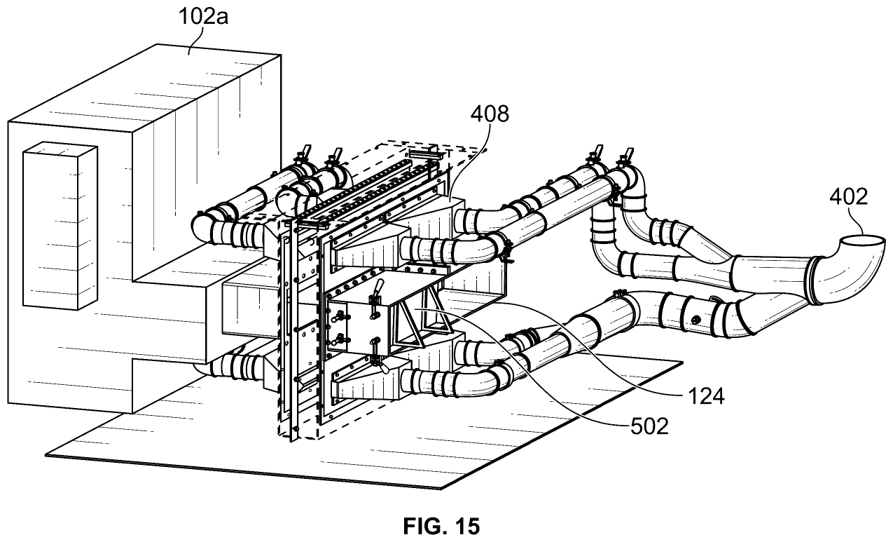

As shown in FIGS. 11 through 15, oven shroud cover plates 502 may be inserted or removed when an apparatus is retracted so as to enable the system to operate with fewer than all apparatuses in place. This may be useful, for example, to enable an apparatus to be retracted for maintenance while still operating the system to coat a portion of a material.

In the embodiment shown, the medium is contemplated as being a material having a first, “top” side and a second, “bottom” side. In an embodiment, the medium is a metal sheet. Other configurations of materials (which may necessitate additional apparatuses) are also contemplated. In the embodiment shown, the medium is passed vertically between the top-coating apparatus 102a and the bottom-coating apparatus 102b. Uncoated material is sprayed simultaneously by the bottom-coating apparatus 102b and the top-coating apparatus 102a so as to simultaneously coat both sides of the material. The coated material is then passed through the oven 106 for curing.

In an embodiment, the oven 106 heats the coated material to treat the coating and improve chemical resistance, improve resistance to harsh environmental conditions, and maintain color stability. In an embodiment, the oven 106 heats the coated material to a temperature range of about 400 to 550 degrees Fahrenheit.

While FIG. 1 and other Figures provided herewith depict a vertically oriented medium grounded to earth passing between the pair of electrostatic coating apparatuses 102a, 102b, the electrostatic coating system 100 may be placed in any orientation resulting in a medium also oriented in any orientation. One of ordinary skill in the art understands that the medium may be a linear, rigid strip of material or a rolled medium which is unfolded before passing through the electrostatic coating system 100 before again being rolled, folded, or stored. It is also understood that any type of medium, made of any type of conductive or nonconductive material and presenting a variety of surface geometry and topology, can be coated. While in embodiments the medium is grounded using conventional grounding techniques, the electrostatic coating system 100 functions on attractive forces created between the powder particles and the medium by creating a difference in ionic potential, so what is contemplated is the use of a medium at any ionic potential sufficiently different from the average ionic potential of the particles emitted by the electrostatic coating system 100 to induce electrostatic attraction forces. In embodiments, the medium is effectively a two-dimensional strip with negligible thickness relative to its height and width. In other embodiments, the medium has a three-dimensional structure and is coated on more than two sides, in which case additional apparatuses in other arrangements may be employed so as to coat all surfaces of the medium.

In the embodiment shown, the top-coating apparatus 102a is substantially identical in structure to the bottom-coating apparatus 102b. The enclosures 104a, 104b are depicted in FIG. 1 as an open frame. In other examples, the enclosures 104a, 104b have a solid exterior. In an embodiment, enclosures 104a, 104b are NEMA-4 enclosures that house pneumatic controls and powder supplies for the apparatus.

The components of each apparatus 102a, 102b are made of a thick wall of strength sufficient to contain internal pressures created during the process of suspending the powder particles within a gas, also known as fluidization of the particles. FIG. 1 shows one possible industrial and commercial embodiment of the disclosure. These figures show a stainless steel casing with surface strengtheners described in detail hereinafter. The fluidization process includes the use of a pump (not shown) that supplies pressurized air to each apparatus 102 through a plurality of air inlets 108. Each apparatus 102 also comprises a plurality of powder deposition devices 500 (also termed PowderJets®) connected to a plurality of powder inlets 108 via supply lines (not shown) running between the “bottom” of each powder inlet 108 and an inlet on the respective powder deposition device 500. Each powder deposition device 500 discharges a controlled volume of particles in a powder form to be coated on the medium.

In embodiments, a powder management system (not shown), such as that disclosed in co-pending U.S. patent application Ser. No. 17/976,549 (the contents of which are hereby incorporated by reference herein in their entirety) is connected to each powder deposition device 500. In embodiments, each powder management system comprises a compressor that provides compressed air to a wet air receiver. The compressed air then is fed to a dryer/conditioner (e.g., a desiccant air dryer) before being passed to a dry air receiver where it is stored until needed. Dry air is then fed to each deposition device 500.

Each separate apparatus 102 is then fed by a distinct air supply comprising an air line from the dry air receiver to a bag hoist tower, which is itself coupled in turn to a hopper and scale tower, a powder line, and a splitter (such as, in embodiments, a resistive splitter). In embodiments, each apparatus 102 is fitted with a separate accessory air manifold that receives dry air from the dry air receiver via an air supply line and provides air and a powdered air mixture to the deposition device 500.

In embodiments, the powder management system provides a desired amount of powder coating material (or paint) paint to each of the deposition devices 500 in the apparatuses 102a, 102b. A hopper stores a volume of powder and delivers the powder to a scale tower prior to feeding the powder into the apparatuses 102a, 102b. The air inlet 108 or splitter evenly distributes the powder and air into each deposition device 500 (where it ultimately enters a mixing chamber, as discussed below) for consistency and to enable even distribution of the powder air mixture to a medium. Specifically, the inlet 108 splits the incoming mixture to distribute an even volume of powder throughout the apparatuses 102a, 102b such that a uniform film is applied across the width of the medium. Other arrangements are also contemplated.

In an embodiment of the electronic coating system 100, enclosures 104a, 104b comprise a solid outer surface (such as metal sheeting) which conceals the apparatus 102 within from view and protects it from physical impacts. Such solid enclosures 104a, 104b are each comprised of panels and further serve to insulate the apparatus 102 from ambient temperature changes. In other embodiments, such as also shown in FIG. 1, an enclosure 104b may be at least partially open to permit access to the apparatus 102b within while still providing some degree of physical protection. Other configurations of enclosures 104a, 104b are also contemplated. In an embodiment, the exterior surface (i.e., of the panels) of the enclosures 104a, 104b is formed from sheets of 80/20 extruded aluminum that is joined to an interior frame by t-nut connectors. Each apparatus 102a, 102b is supported within the enclosures 104a, 104b by neoprene rubber isolators to reduce vibrations. In other embodiments, alternative materials or other techniques for vibration damping may be used, as will be understood by one of ordinary skill in the art. In an embodiment, the panels of the enclosures 104a, 104b are removable to allow a user to partially or fully open the enclosures 104a, 104b and access the interior of the apparatuses 102a, 102b.

In embodiments, the apparatuses 102 are each secured to their respective frame 105 by a plurality of mounting brackets. These mounting brackets may be made of metal and include neoprene rubber isolators, as discussed above, thereby reducing the vibration passed between each apparatus 102a, 102b and its respective frame 105.

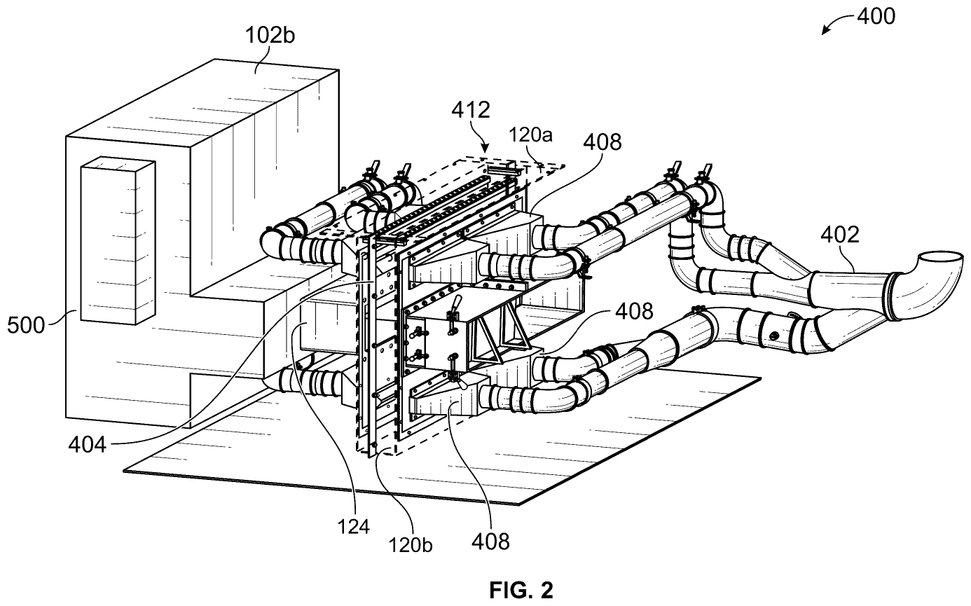

As shown in FIGS. 1 and 2, in embodiments an overspray collection system 400 (the “reclaim system” or “collection unit”) is employed to collect overspray from a plurality of apparatuses 102a, 102b coating multiple surfaces of a medium. As will be clear to one of ordinary skill in the art, alternative arrangements are also contemplated hereby, including but not limited to having a separate reclaim system 400 for each apparatus 102.

When powder oversprays, or is not electrostatically seated on the medium, it may be collected by the reclaim system 400 for disposal, recycling, and/or reuse. In embodiments, a vacuum motor (not shown) in the collection unit 400 is operatively connected to piping 402 and is used to create a low pressure area in the piping 402 and interior of one or more reclaim hoods 408, ingesting the oversprayed powder into the reclaim system. In the embodiment shown in FIGS. 1 and 2, the spray area around one or more apparatuses 102 is substantially covered by a shroud 120 to prevent overspray from escaping the deposition area. The vacuum motor is sized such that it collects all overspray within the shroud 120. In embodiments, the air/powder mixture collected by the vacuum motor is then passed through a cyclone separator wherein the air is separated from the powder before the powder is filtered into a collection container in a solid form while the air is filtered and vented outside the shroud 120. In embodiments, the powder may then be settled and fed into a transport container for recycling or reintroduction into the virgin powder supply. Such recycling and reuse may occur either at a separate location or locally. In embodiments, the powder is transferred via tubing or other structure rather than using a discrete transport container.

In the embodiment of FIGS. 1 and 2, the one or more apparatuses 102 each comprise four reclaim ports 404 through which overspray is evacuated. When powder oversprays, or is not electrostatically seated on the medium, it is pulled through one of the reclaim ports 404 into a reclamation (or “reclaim”) hood 408 attached to piping 402. In embodiments, the overspray powder is drawn into the reclaim ports 404 by a VFD blower motor. In embodiments, the overspray collection system 400 comprises blowback dampers to prevent the overspray from traveling backwards towards the apparatuses 102 in the event that there is an overpressure event or other damage or fault in the reclamation system 400. In embodiments, bag houses comprising nonconductive filter bags which are pulsed with air and any free powder falls into the collectors are utilized to collect reclaimed powder. In embodiments, the VFD blower motor creates the negative pressure which draws the overspray to and through the bag house(s) and its filters.

In this embodiment, the electrostatic coating system 100 has multi-color application capability, enabling the apparatuses 102 to apply single or multiple-color paint and the overspray collection system allows for the colors to be collected independently from the apparatuses 102. As shown, the pairs of apparatuses 102a, 102b are applied oppositely and facing one another. In an embodiment, one apparatus applies the mixture to the top side of the medium and the opposite apparatus applies the mixture to the bottom side of the medium. These apparatuses 102a, 102b allow application of the mixture on each side of the medium simultaneously. In embodiments, apparatuses are placed side-by-side or sequentially, allowing multiple layers and/or different layers to be deposited on the same side of a material.

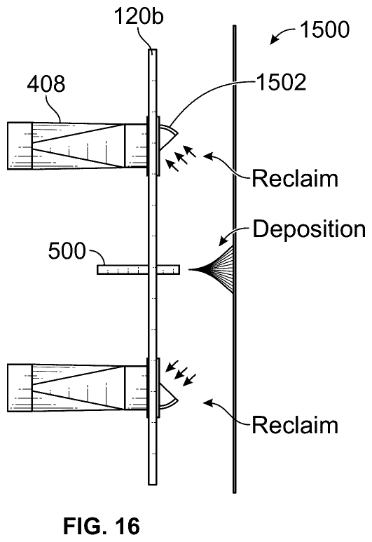

FIG. 16 illustrates an embodiment of a pair of reclamation hoods 408 each featuring a scoop 1502 that extends into the deposition area to assist with capturing excess powder. As shown, powder is deposited using powder deposition device 500, with a pair of reclamation hoods 408 spaced apart with one above and one below the deposition area. During deposition, each reclamation hood 408 ingests oversprayed powder, ensuring that all powder within shroud 120, 124 that does not deposit on the material is captured to prevent escape into the facility (which could result in the creation of a dangerous powder/air mixture).

### Retraction of Apparatuses

As shown, each apparatus 102a, 102b and its respective enclosure 104a, 104b may be supported by wheels 114 and configured to slide along rails 116 so as to permit access to the apparatuses 102a, 102b by moving it away from the oven 106 and oven shroud 120b. This permits each apparatus 102a, 102b and the oven 106 and oven shroud 120b to be more easily inspected or maintained. As shown, each apparatus 104a, 104b may be slid along rails 116 laterally away from the oven 106. The oven shroud 120a, 120b in embodiments comprises a strip shroud 120 that is removably connected to the bottom of the oven 106, which protects the medium and spray area from airborne dust or other contamination. Further, the strip shroud 120 may be slid away from the oven 106 to permit easier access to the oven 106, apparatuses 102 or the medium for inspection and cleaning. In an embodiment, the strip shroud 120 is a permanent structure and can flexibly join to the apparatuses to prohibit powder escapes during operation. In such embodiment, the retraction of the strip shroud 120 is controlled by a pneumatic piston system, the pneumatic piston system comprising a silicone boot which provides a means for retracting the strip shroud 120 from the oven 106 and allowing a user access to the oven 106 and interior of the strip shroud.

In an embodiment, the electrostatic coating system 100 is configured to implement a cleaning mode wherein all air and residual powder are completely evacuated from within the shroud 102. Such mode may be used, for example, prior to retracting the shroud to inspect the oven 106 and/or apparatuses 102. Further, during regular operation, the electrostatic coating system 100 may be configured to evacuate only the motive gas and excess powder material from the shroud (e.g., so as to collect overspray as it occurs).

### Powder Deposition Device

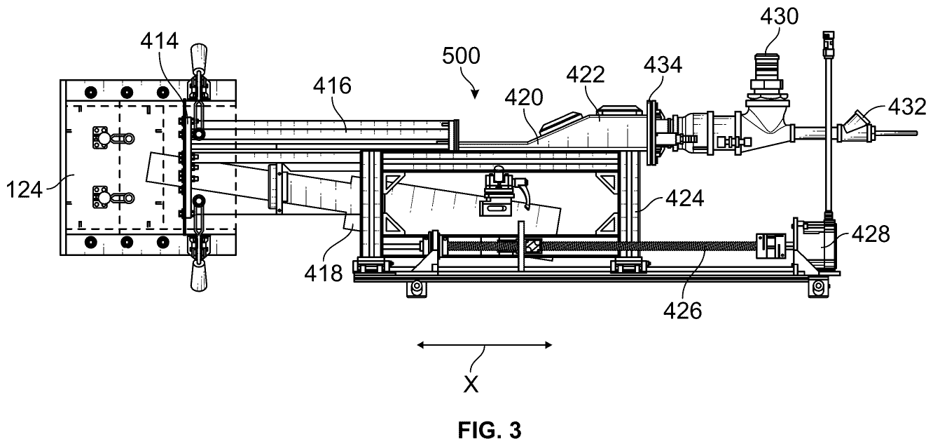

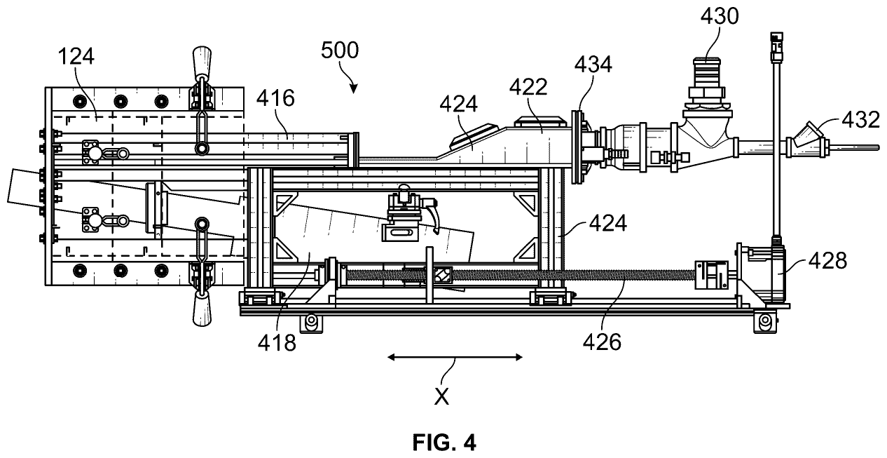

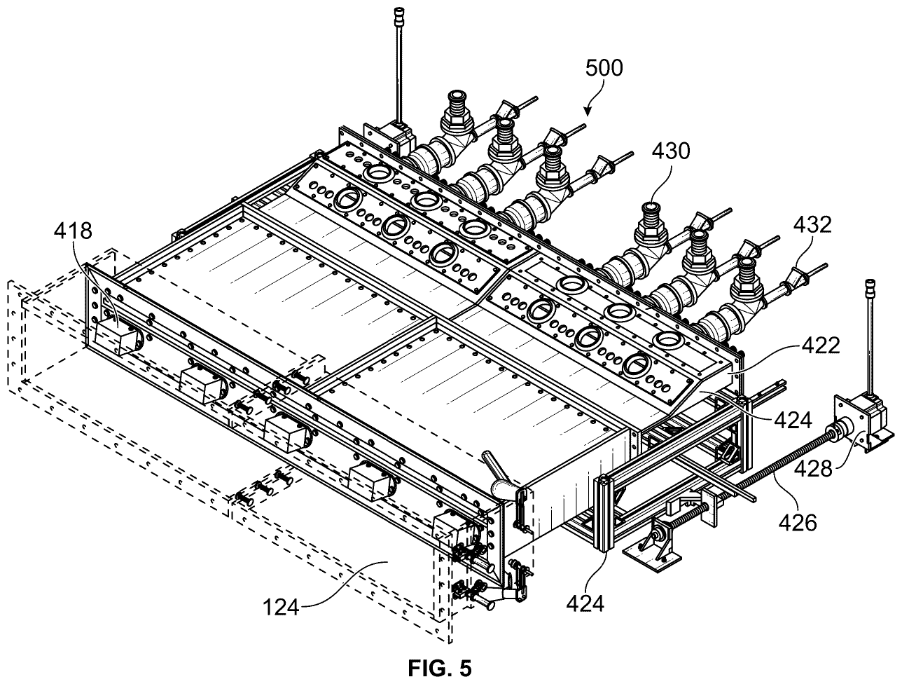

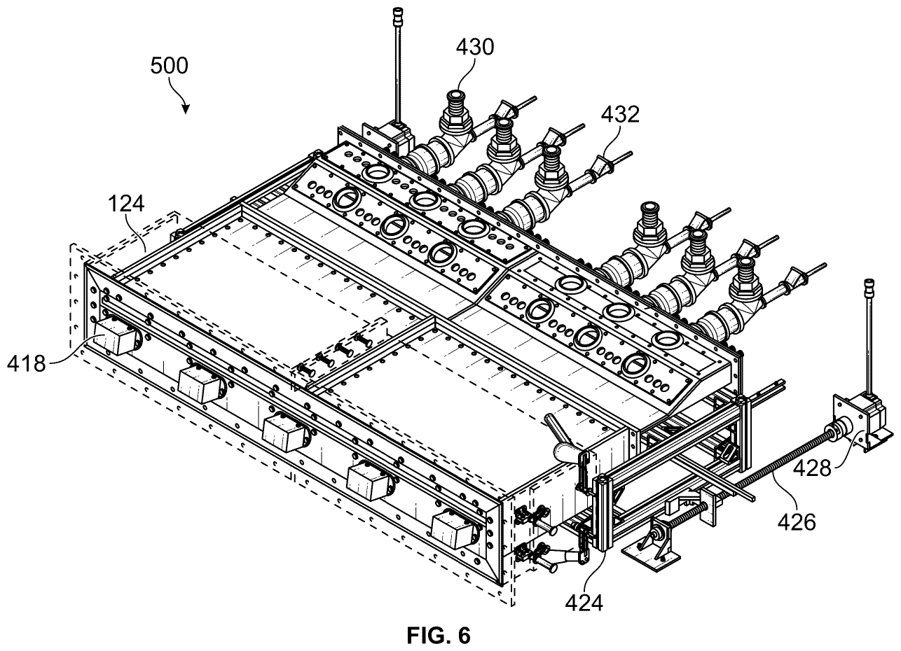

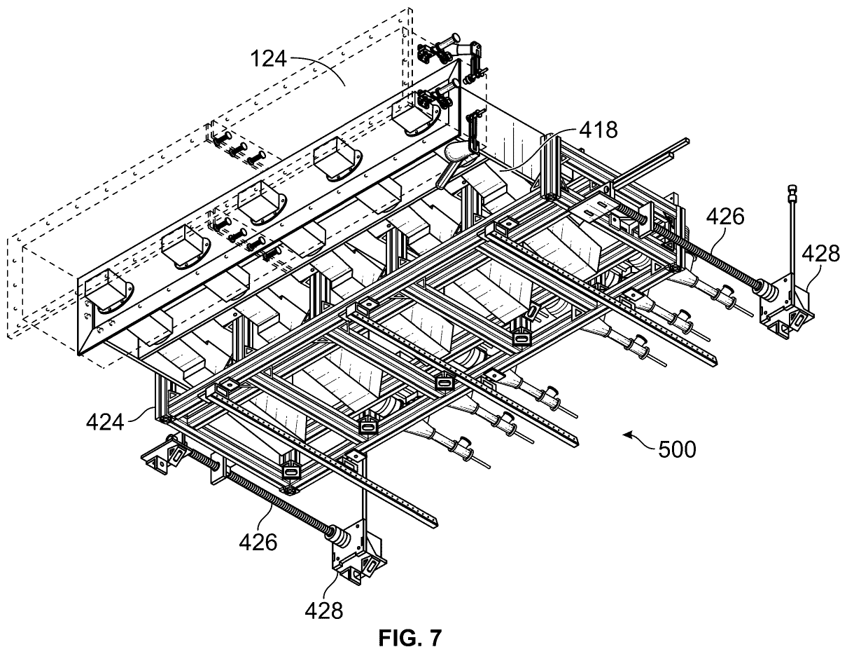

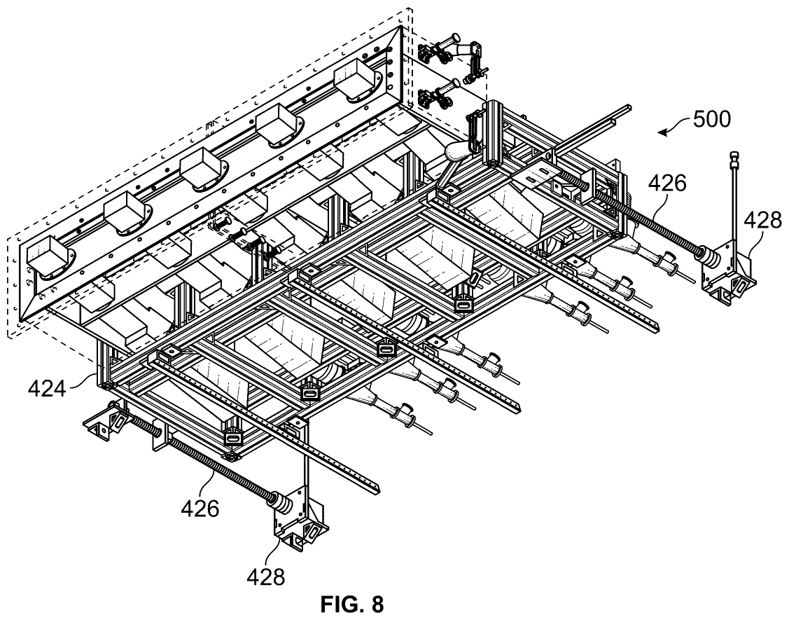

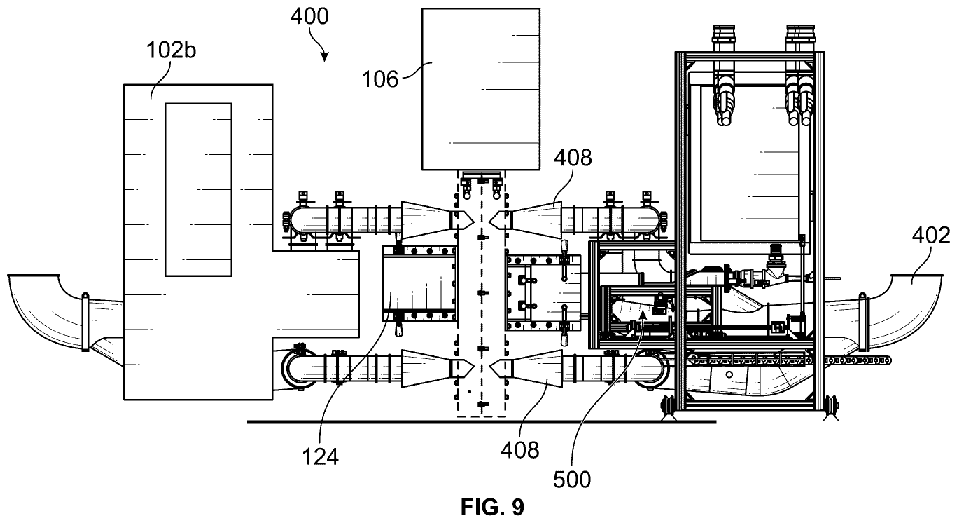

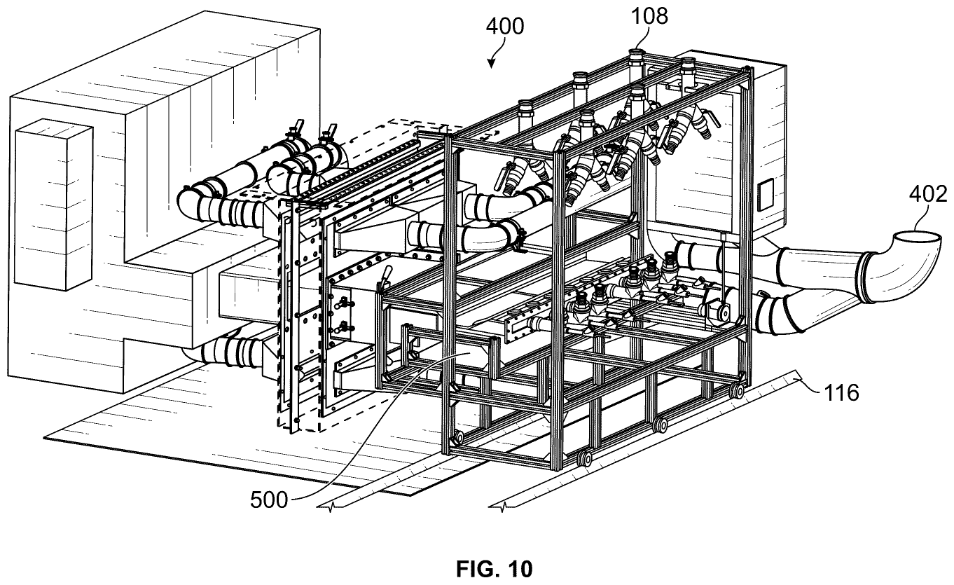

FIGS. 3 through 8 depict an embodiment of a powder deposition device 500. As shown, each deposition device comprises an electrostatic emitter 418 mounted to a movable frame 424. The movable frame 424 is configured to move towards and away from the medium along axis X and is mounted to screw 426 which is operatively connected to motor 428. By rotating screw 426, motor 428 can either extend or retract each frame 424 and the associated components.

Each frame further supports a mixing chamber 422 which receives a powdered air mixture through powder inlet 432 as well as secondary air through air inlet 430. This arrangement is preferred in some embodiments as it has experimentally been demonstrated to produce an even distribution of powder and air throughout the mixing chamber 422. As will be clear to one of ordinary skill in the art, other arrangements of openings are also contemplated.

The powder and air enter mixing chamber 422 before passing through converging nozzle 420 and nozzle extension 416 before being ejected through one or more openings in seal plate 414 and ultimately being deposited on the medium. Oven shroud extension 124 seals against seal plate 414 so as to create a barrier around the deposition area.

In the embodiment shown, the secondary air inlet 430 is located on the top of the mixing chamber 306, while the powder/air mixture enters through inlet 432 at the rear of the mixing chamber 306. This arrangement provides additional separation between the air inlets 430 and the powder inlet 432, allowing the air and powder to mix and flow uniformly into the mixing chamber 422. Specifically, the flow of air through air inlet 430 controls the flow volume of conditioned air to the mixing chamber 422 to vary the thickness of the mixture of powder particles and air particles (the “mixture”). Increased air flow leads to a thinner mixture. Alternatively, decreased air flow increases the thickness of the mixture. As a result, modulation of the air flow in the air inlet 430 impacts the finish and thickness of the coating applied to the surface of the medium.

Air and powder are intermixed and fluidized in the mixing chamber 422 before exiting through openings (not shown) in the seal plate 414. The fluidized air/powder mixture is ejected into the zone of ionization created by emitters 418 within the shrouds 120, 124 which electrostatically charges the mixture. When the electrostatically charged mixture is discharged and applied to the medium, the powder flows to the surface of the medium to ground the charge. Therefore, electrostatic charge helps the mixture “stick” to the surface of the medium and provides an even application of the mixture to the medium. The ionized powder (having a negative charge) is attracted to the grounded surface and electrostatically adheres to the surface of the medium.

In an embodiment, the interior surface of the air flow path from powder inlet 432 through the openings in the seal plate 414 is substantially smooth and uninterrupted to ensure the fluidized powder/air mixture flows uninterrupted. Excess powder (i.e., overspray) is evacuated from the electrostatic/vacuum chamber through the reclamation system as discussed herein. In an embodiment, the electrostatic/vacuum chamber comprises at least one reclaim port 404 and a diverter to control the flow of overspray.

It is understood that while one possible air mixing configuration is shown any configuration where gas can be used, funneled, and directed to fluidize the powder into suspended particles is contemplated.

In the embodiments shown and discussed, each apparatus 102 (and its constituent components) have been described as generally identical in nature and arrangement. As will be clear to one of skill in the art, in embodiments, specific apparatuses 102 (or the components thereof) may be customized or otherwise differ in comparison to others in the facility to fulfill a distinct role. By way of example, deposition devices 500 located on the “outside” of an apparatus 102 may be configured differently than deposition devices 500 located on the “interior” of an array in an apparatus 102 so as to ensure the edges of material are properly coated. Alternatively, a top coat apparatus may differ from a bottom coat apparatus due to the differing requirements on opposite sides of a material. Other variations are also contemplated based on the needs of particular applications.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

What is claimed is:

1. An electrostatic coating system comprising:
one or more powder deposition devices, each comprising:
a frame;
a mixing chamber connected to the frame, the mixing chamber receiving a first supply of air and a second supply of powder and intermixing and fluidizing the powder;
an electrostatic emitter connected to the frame, the electrostatic emitter configured to generate an electrostatic field to propel the fluidized mixture of powder onto a medium; and
a motor configured to move the frame along an axis between a first position proximate the medium and a second position separated from the medium.

2. The electrostatic coating system of claim 1, wherein the one or more powder deposition devices each comprise a screw, the screw being mounted to the frame and operatively connected to the motor;
wherein, the motor moves the frame between the first and second position upon rotation of the screw.

3. The electrostatic coating system of claim 1, wherein the one or more powder deposition devices each comprise a nozzle extending from the mixing chamber, the nozzle providing a path for the fluidized mixture of powder to move toward the electrostatic emitter.

4. The electrostatic coating system of claim 1, wherein the mixing chamber comprises an air inlet proximate the top of the mixing chamber and a powder inlet at the rear of the mixing chamber.

5. The electrostatic coating system of claim 1, wherein the thickness of the fluidized mixture is proportional to the flow rate of the first supply of air and the second supply of powder entering the mixing chamber.

6. The electrostatic coating system of claim 1, wherein the one or more powder deposition devices each comprise a top coating apparatus to coat a top surface of the medium and a bottom coating apparatus to coat a bottom surface of the medium, wherein the top coating apparatus is offset from the bottom coating apparatus.

7. The electrostatic coating system of claim 1, further comprising an oven to cure the coating of powder disposed on the medium.

8. The electrostatic coating system of claim 7, wherein the oven heats the coating of powder disposed on the medium to a temperature range of about 400 to 550 degrees Fahrenheit.

9. The electrostatic coating system of claim 1, further comprising an overspray collection system to collect overspray powder which fails to apply to the medium.

10. The electrostatic coating system of claim 9, wherein the overspray collection system comprises:
a shroud to prevent overspray from escaping the spray area;
a plurality of reclaim ports, the reclaim ports connected to a reclaim hood;
a plurality of pipes extending from the reclaim hood; and
a vacuum motor to generate a low pressure area within the pipes and pull overspray powder through the reclaim ports, reclaim hood and pipes and away from the powder deposition devices and towards bag houses to store overspray power.

11. The electrostatic coating system of claim 1, further comprising rails to permit movement of the one or more powder deposition devices.

12. The electrostatic coating system of claim 11, wherein the one or more powder deposition devices each comprise a plurality of wheels configured to slide along the rails and permit access to the powder deposition devices.
